(19) United States
(12) Patent Application Publication
(10) Pub. No.: US 2021/0042692 A1
(43) Pub. Date: Feb. 11, 2021

(54) PROACTIVE HARDWARE INVENTORY MANAGEMENT

(71) Applicant: NewPower, Inc., Riverside, CA (US)

(72) Inventor: THOMAS SHAFFER, Murietta, CA (US)

(73) Assignee: NewPower, Inc., Riverside, CA (US)

(21) Appl. No.: 16/987,375

(22) Filed: Aug. 6, 2020

Related U.S. Application Data
(60) Provisional application No. 62/883,456, filed on Aug. 6, 2019.

(51) Int. Cl. G06Q 10/08; G05B 19/418

(52) U.S. Cl. CPC G06Q 10/0833; G05B 19/41805; G05B 19/4183; G06Q 10/0875

(57) ABSTRACT

Apparatuses, systems, methods, and computer program products are described for proactive hardware inventory management. A method includes manufacturing a plurality of custom hardware components for a plurality of installation projects. A method includes serializing the custom hardware components. A method includes associating the serialized custom hardware components with the plurality of installation projects.

### CROSS-REFERENCES TO RELATED APPLICATIONS

This application claims the benefit of U.S. Provisional Patent Application No. 62/883,456 entitled “PROACTIVE HARDWARE INVENTORY MANAGEMENT” and filed on Aug. 6, 2019, for Thomas Shaffer, which is incorporated herein by reference in its entirety for all purposes.

### FIELD

The subject matter disclosed herein relates generally to hardware manufacturing and more particularly relates to inventory management of proactively manufactured custom hardware.

### BACKGROUND

Hardware components may be manufactured with little or no tracking or management prior to their use, other than tracking general quantities, costs, or the like. However, this lack of tracking or management may lead to a mismatch in the hardware components that have been manufactured and the actual hardware installation projects, or to an inability to qualify for certain benefits related to the hardware installation projects at the time of manufacture. For example, without certain tracking and/or management, it may not be possible to show when construction has commenced for a hardware installation project, or the like.

### BRIEF SUMMARY

Apparatuses, systems, methods, and computer program products are described for proactive hardware inventory management. A method, in one embodiment, includes manufacturing a plurality of custom hardware components for a plurality of installation projects. In certain embodiments, a method includes serializing custom hardware components. A method, in a further embodiment, includes associating serialized custom hardware components with a plurality of installation projects.

An apparatus, in one embodiment, includes means for manufacturing a plurality of custom hardware components for a plurality of installation projects. In a further embodiment, an apparatus includes means for serializing custom hardware components. An apparatus, in some embodiments, includes means for associating serialized custom hardware components with a plurality of installation projects.

A system, in certain embodiments, includes a plurality of custom manufactured photovoltaic hardware components for a plurality of photovoltaic installation projects. Serialized identifiers, in one embodiment, are disposed on each of a plurality of custom manufactured photovoltaic hardware components indicating at least a date of manufacture. A plurality of receptacles, in some embodiments, physically associate custom manufactured photovoltaic hardware components with different photovoltaic installation projects.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for proactive hardware inventory management;

FIG. 2 is a schematic block diagram of one embodiment of a custom hardware component;

FIG. 3 is a schematic block diagram of a further embodiment of a custom hardware component;

FIG. 4 is a schematic block diagram of another embodiment of a custom hardware component;

FIG. 5 is a schematic block diagram of a certain embodiment of a custom hardware component;

FIG. 6 is a schematic block diagram of an embodiment of a custom hardware component;

FIG. 7 is a schematic flow chart diagram illustrating one embodiment of a method for proactive hardware inventory management; and

FIG. 8 is a schematic flow chart diagram illustrating a further embodiment of a method for proactive hardware inventory management.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

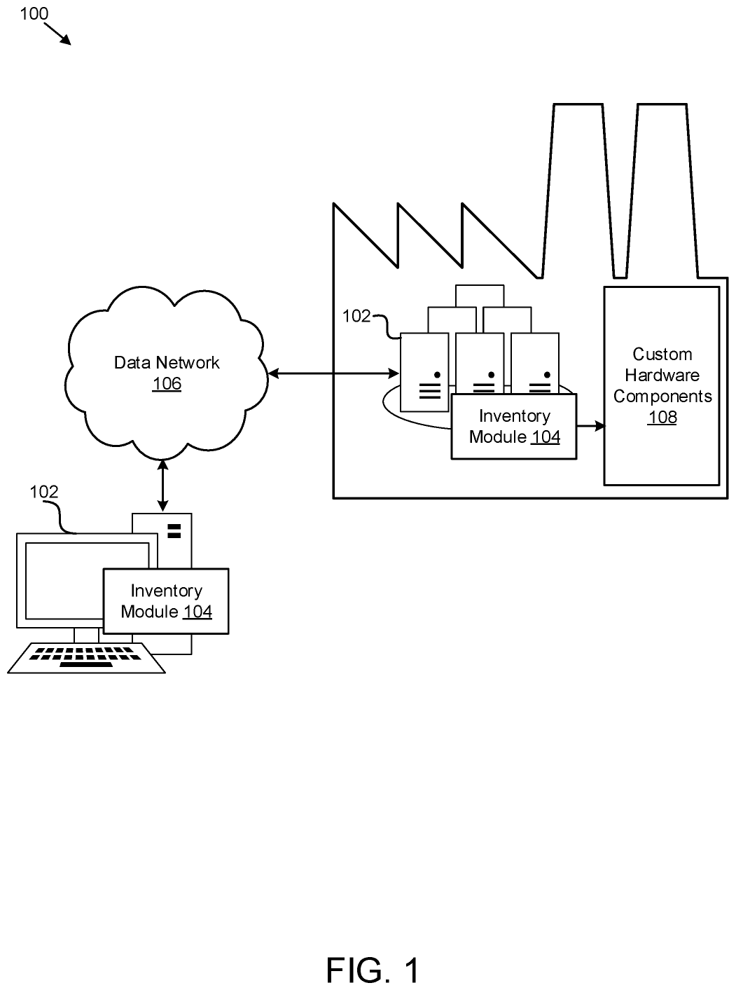

FIG. 1 depicts one embodiment of a system 100 for proactive hardware inventory management. In one embodiment, the system 100 includes one or more hardware devices 102, one or more inventory modules 104 (e.g., a backend inventory module 104 and/or a plurality of inventory modules 104 disposed on the one or more hardware devices 102), and/or one or more data networks 106 or other communication channels, for the proactive manufacturing and/or management of a plurality of custom hardware components 108 or the like. In certain embodiments, even though a specific number of hardware devices 102, inventory modules 104, and/or data networks 106 are depicted in FIG. 1, one of skill in the art will recognize, in light of this disclosure, that any number of hardware devices 102, inventory modules 104, data networks 106, and/or custom hardware components 108 may be included in the system 100.

In one embodiment, an inventory module 104 is configured to proactively manage hardware inventory. For example, in some embodiments, the inventory module 104 may serialize, assign to installation projects, and/or otherwise manage one or more hardware components 108, even before the components 108 are sold, the installation projects are scheduled and/or ordered, or the like (e.g., during a previous year for installation projects to be scheduled in a subsequent year, or the like). Manufacturing, tracking, and/or associating custom hardware components 108 with installation projects prior to the actual installation projects may have certain tax, budgeting, logistic, and/or other benefits (e.g., a tax credit and/or refund may be legally claimed in an earlier tax year, a higher amount may be claimed, or the like), may help ensure that a proper amount of hardware components 108 are manufactured for subsequent installation projects, or the like.

In certain embodiments, the inventory module 104 may be configured to manufacture (e.g., initiate a manufacturing process, monitor and/or track a manufacturing process, authorize a manufacturing process, oversee a manufacturing process, control an automated manufacturing process and/or a portion thereof, or the like) a plurality of custom hardware components 108 for a plurality of installation projects. For example, in some embodiments, the custom hardware components 108 manufactured by and/or for the inventory module 104 may comprise one or more hardware components 108 of a photovoltaic/solar system (e.g., photovoltaic panels, photovoltaic panel mounts, or the like), such as photovoltaic panels and/or components thereof, photovoltaic mounting baseplates, photovoltaic mounting tile hooks, photovoltaic mounting carriage bolts, photovoltaic mounting flashings, photovoltaic mounting L-foots, photovoltaic racking components, photovoltaic rail components, photovoltaic mounting clamps, photovoltaic inverters, photovoltaic support structures, or the like.

In response to the custom hardware components 108 being manufactured (e.g., receiving the manufactured custom hardware components 108, or the like), in one embodiment, the inventory module 104 is configured to serialize (e.g., organize and/or index) the custom hardware components 108. For example, the inventory module 104 may assign serial numbers, dates, labels, and/or other unique identifiers to the custom hardware components 108 (e.g., by year of manufacture, by entity for which the custom hardware components 108 were manufactured, in an order in which the custom hardware components 108 were manufactured, in an order in which the custom hardware components 108 were received, in an order in which the inventory module 104 processes the custom hardware components 108, and/or in another order). For example, the inventory module 104 may label custom hardware components 108 with serialized identifiers indicating at least a date of manufacture for the custom hardware components 108, or the like.

In one embodiment, a serial number or other unique identifier for a custom hardware component 108 comprises an identifier of at least a year or other time period (e.g., day, month, quarter, or the like) in which the custom hardware component 108 was manufactured. In a further embodiment, a serial number or other unique identifier for a custom hardware component 108 comprises a name and/or other identifier of an entity (e.g., a company or other business entity) for which the custom hardware component 108 was manufactured. In some embodiments, a serial number of other unique identifier for a custom hardware component 108 may include both an identifier of a year or other time period in which the custom hardware component 108 was manufactured and a name or other identifier of an entity for which the custom hardware component 108 was manufactured.

In one embodiment, the inventory module 104 is configured to etch, print, label, stamp, and/or otherwise mark the custom hardware components 108 with a serial number, year or other date, a name of an entity for which the custom hardware components 108 were manufactured, and/or another unique identifier serializing the custom hardware components 108. In a further embodiment, the inventory module 104 is configured to mark a container, packaging, a tag, or the like of the custom hardware components 108.

The inventory module 104, in some embodiments, is configured to associate the serialized custom hardware components 108 with the plurality of installation projects. For example, the inventory module 104 may associate serial numbers and/or other unique identifiers of the custom hardware components 108 with a set of installation projects (e.g., a set of installation projects where one or more of them have not yet been ordered, not yet been scheduled, not yet been assigned, and/or otherwise have not yet been started/initiated). In one embodiment, the inventory module 104 may associate the serialized custom hardware components 108 with the installation projects in an order in which the installation projects are to be performed (e.g., in a time and/or date order).

The inventory module 104, in certain embodiments, may logically associate the serialized custom hardware components 108 with the installation projects (e.g., in a database, data store, and/or other data structure). In a further embodiment, the inventory module 104 may physically associate the serialized custom hardware components 108 with the installation projects (e.g., storing hardware components 108 associated with the same installation project in physical proximity, such as in the same storage location, container, bin, or other physical receptacle, such that the hardware components 108 may be subsequently transported to a location of the associated installation project, in response to scheduling the associated installation project, or the like). For example, the inventory module 104 may store different sets of custom hardware components 108 in physical receptacles or other locations indexed based on the associated plurality of installation projects. A receptacle, as used herein, comprises a physical and/or mechanical location, such as a container, a region of a warehouse or other storage facility, or the like, shaped or otherwise configured to receive and/or store one or more custom hardware components 108 associated with an installation project.

In certain embodiments, the inventory module 104 may associate at least a predefined minimum number of custom hardware components 108 with each installation project. For example, the inventory module 104 may associate a number of custom hardware components 108 based on a minimum number of custom hardware components 108 estimated to be used for a smallest project of the plurality of hardware projects; based on a statutory minimum project completion for a tax credit and/or refund, or other incentive; or the like. For projects using more than the associated number of custom hardware components 108, in some embodiments, the inventory module 104 may subsequently manufacture an additional number of hardware components 108 and later associated them with one or more of the plurality of installation projects (e.g., in order to complete one or more of the installation projects with additional hardware components 108).

The inventory module 104, in one embodiment, is configured to complete the plurality of installation projects using at least the plurality of custom hardware components 108 (e.g., facilitate, initiate, monitor, track, control, and/or otherwise ensure that the installation projects are completed using the custom hardware components 108, or the like). For example, the inventory module 104 may coordinate shipping and/or other transportation of the custom hardware components 108 to locations associated with the installation projects, may monitor and/or otherwise track progress of the installation projects using the custom hardware components 108, or the like.

In one embodiment, the inventory module 104 may track one or more of a manufacture date for a custom hardware component, a start date for an installation project associated with the custom hardware component, a completion date for an installation project associated with the custom hardware component, and/or one or more other event dates associated with the custom hardware component (e.g., for accounting purposes, for auditing purposes, or the like). For example, in certain embodiments, the inventory module 104 may manufacture, serialize, and associate the plurality of custom hardware with the plurality of installation projects in a first year (e.g., a first calendar year, a first fiscal year, a first tax year, or the like) and the inventory module 104 may complete one or more of the plurality of installation projects in a subsequent year (e.g., and the inventory module 104 may track one or more of the associated dates).

The inventory module 104, in some embodiments, may initiate and/or begin work on the plurality of installation projects in a serialized order of the serialized custom hardware components 108. For example, the inventory module 104 may serialize the custom hardware components 108 using serial numbers and/or other ordered, unique, identifiers and may follow the serialized order (e.g., a numerical order of the serial numbers, a numerical and/or alphabetic order of another unique identifier, or the like) for ordering the installation projects associated with the custom hardware components 108 (e.g., starting work on new installation projects in an order based on the serialization of the custom hardware components 108, or the like).

In various embodiments, an inventory module 104 may be embodied as hardware, software, or some combination of hardware and software. In one embodiment, an inventory module 104 may comprise executable program code stored on a non-transitory computer readable storage medium for execution on a processor of a hardware device 102, a backend server 102, or the like. For example, an inventory module 104 may be embodied as executable program code executing on one or more of a hardware device 102, a backend server 102, a combination of one or more of the foregoing, or the like. In such an embodiment, the various modules that perform the operations of an inventory module 104, as described below, may be located on a hardware device 102, a backend server 102, a combination of the two, and/or the like.

In various embodiments, an inventory module 104 may be embodied as a hardware appliance that can be installed or deployed on a backend server 102, on a user's hardware device 102 (e.g., a dongle, a protective case for a phone 102 or tablet 102 that includes one or more semiconductor integrated circuit devices within the case in communication with the phone 102 or tablet 102 wirelessly and/or over a data port such as USB or a proprietary communications port, or another peripheral device), or elsewhere on the data network 106 and/or collocated with a user's hardware device 102. In certain embodiments, an inventory module 104 may comprise a hardware device such as a secure hardware dongle or other hardware appliance device (e.g., a set-top box, a network appliance, or the like) that attaches to another hardware device 102, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of an inventory module 104 may comprise a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to an inventory module 104.

An inventory module 104, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, an inventory module 104 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of an inventory module 104.

The semiconductor integrated circuit device or other hardware appliance of an inventory module 104, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of an inventory module 104 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

In one embodiment, the system 100 includes one or more hardware devices 102. The hardware devices 102 (e.g., computing devices, information handling devices, or the like) may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware devices 102 are in communication with one or more servers 102 and/or other hardware devices 102 via a data network 106, described below. The hardware devices 102, in a further embodiment, are capable of executing various programs, program code, applications, instructions, functions, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

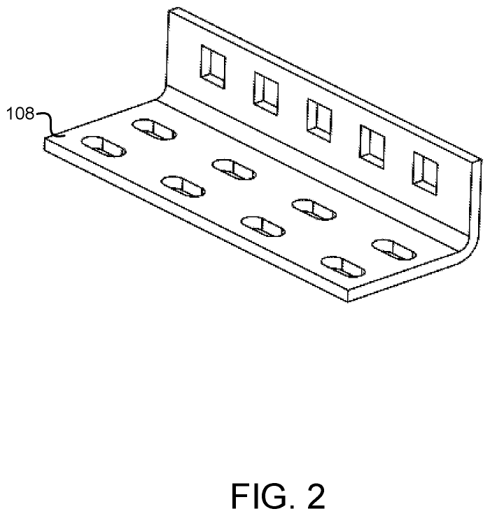

FIG. 2 depicts one embodiment of a custom manufactured photovoltaic hardware component 108. The custom hardware component 108 of FIG. 2, in some embodiments, may be substantially similar to one or more of the custom hardware components 108 of FIG. 1. In FIG. 2, the custom hardware component 108 comprises a photovoltaic mounting baseplate 108. In other embodiments, a custom hardware component 108 may comprise one or more other manufactured and/or otherwise formed components.

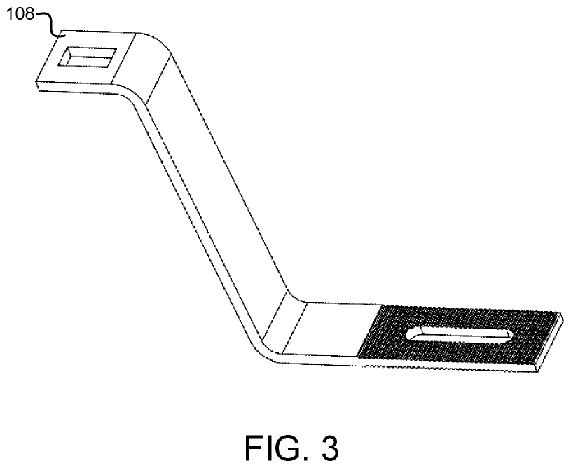

FIG. 3 depicts a further embodiment of a custom manufactured photovoltaic hardware component 108. The custom hardware component 108 of FIG. 3, in some embodiments, may be substantially similar to one or more of the custom hardware components 108 of FIG. 1. In FIG. 3, the custom hardware component 108 comprises a photovoltaic tile hook 108. In other embodiments, a custom hardware component 108 may comprise one or more other manufactured and/or otherwise formed components.

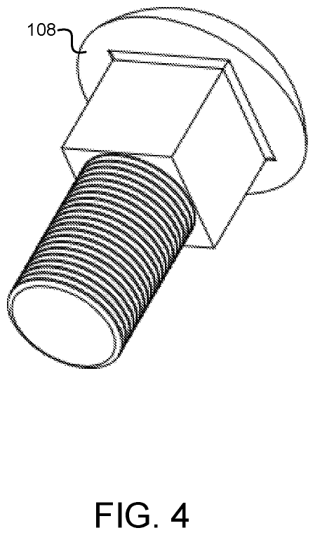

FIG. 4 depicts another embodiment of a custom manufactured photovoltaic hardware component 108. The custom hardware component 108 of FIG. 4, in some embodiments, may be substantially similar to one or more of the custom hardware components 108 of FIG. 1. In FIG. 4, the custom hardware component 108 comprises a photovoltaic mounting carriage bolt 108. In other embodiments, a custom hardware component 108 may comprise one or more other manufactured and/or otherwise formed components.

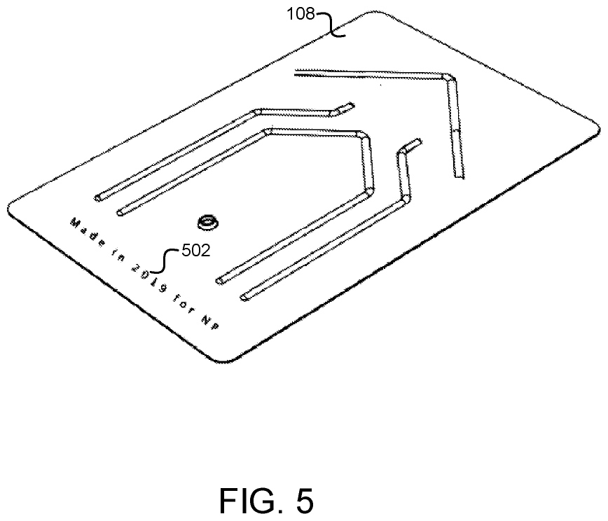

FIG. 5 depicts a certain embodiment of a custom manufactured photovoltaic hardware component 108. The custom hardware component 108 of FIG. 5, in some embodiments, may be substantially similar to one or more of the custom hardware components 108 of FIG. 1. In FIG. 5, the custom hardware component 108 comprises a photovoltaic mounting flashing 108. In other embodiments, a custom hardware component 108 may comprise one or more other manufactured and/or otherwise formed components.

In the depicted embodiment, the custom hardware component 108 comprises a serialized identifier 502. The serialized identifier, in the depicted embodiment, includes an identifier of a year in which the custom hardware component 108 was manufactured, and an identifier of an entity (e.g., a company or other business entity) for which the custom hardware component 108 was manufactured. In other embodiments, a serialized identifier 502 may comprise a serial number and/or another unique identifier (e.g., instead of or in addition to a year or other time period identifier, a name, or the like).

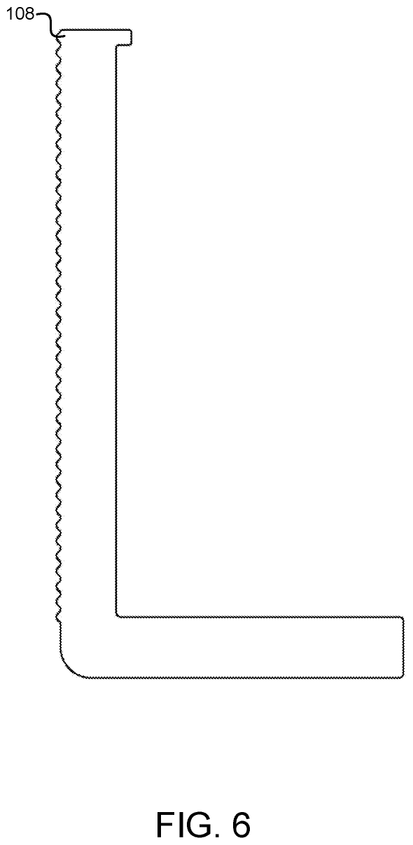

FIG. 6 depicts an embodiment of a custom manufactured photovoltaic hardware component 108. The custom hardware component 108 of FIG. 6, in some embodiments, may be substantially similar to one or more of the custom hardware components 108 of FIG. 1. In FIG. 6, the custom hardware component 108 comprises a photovoltaic mounting L-foot 108. In other embodiments, a custom hardware component 108 may comprise one or more other manufactured and/or otherwise formed components.

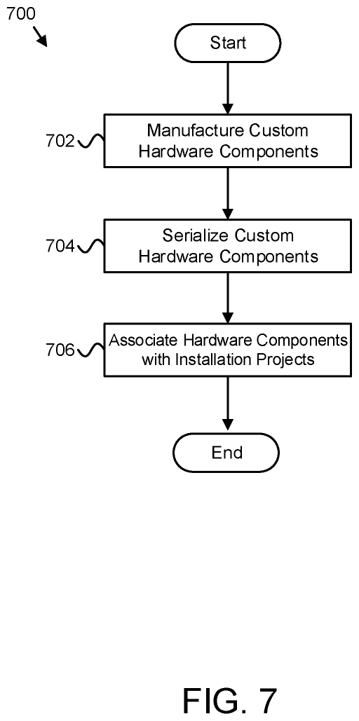

FIG. 7 depicts one embodiment of a method 700 for proactive hardware inventory management. The method 700 begins and an inventory module 104 manufactures 702 a plurality of custom hardware components 108 for a plurality of installation projects. An inventory module 104 serializes 704 the manufactured 702 custom hardware components 108. An inventory module 104 associates 706 the serialized 704 custom hardware components 108 with the plurality of installation projects and the method 700 ends.

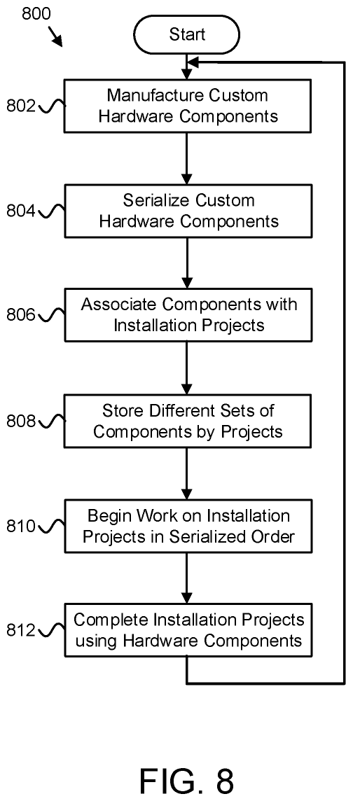

FIG. 8 depicts another embodiment of a method 800 for proactive hardware inventory management. The method 800 begins and an inventory module 104 manufactures 802 a plurality of custom hardware components 108 for a plurality of installation projects.

An inventory module 104 serializes 804 the manufactured 802 custom hardware components 108. An inventory module 104 associates 806 the serialized 804 custom hardware components 108 with the plurality of installation projects. An inventory module 104 stores 808 different sets of the plurality of custom hardware components 108 in locations indexed by the associated 806 plurality of installation projects.

An inventory module 104 begins 810 work on the plurality of installation projects in a serialized 804 order of the custom hardware components 108. An inventory module 104 completes 812 the plurality of installation projects using the plurality of custom hardware components 108 based on the association 806 and the method 800 continues with manufacturing 802 a subsequent set of custom hardware components 108.

A means for manufacturing a plurality of custom hardware components 108, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), fabrication machinery, robotic equipment, an assembly line, other logic hardware, and/or other executable code stored on a computer readable storage medium. Other embodiments may include similar or equivalent means for manufacturing a plurality of custom hardware components 108.

A means for serializing custom hardware components 108, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a stamp, a printer, an etching machine, other logic hardware, and/or other executable code stored on a computer readable storage medium. Other embodiments may include similar or equivalent means for serializing custom hardware components 108.

A means for associating serialized custom hardware components 108 with a plurality of installation projects, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), other logic hardware, and/or other executable code stored on a computer readable storage medium. Other embodiments may include similar or equivalent means for associating serialized custom hardware components 108 with a plurality of installation projects.

A means for completing a plurality of installation projects using a plurality of custom hardware components 108, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), one or more custom hardware components 108, installation equipment/machinery, other logic hardware, and/or other executable code stored on a computer readable storage medium. Other embodiments may include similar or equivalent means for completing a plurality of installation projects using a plurality of custom hardware components 108.

A means for beginning work on a plurality of installation projects in a serialized order of serialized custom hardware components 108, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), one or more custom hardware components 108, installation equipment/machinery, other logic hardware, and/or other executable code stored on a computer readable storage medium. Other embodiments may include similar or equivalent means for beginning work on a plurality of installation projects in a serialized order of serialized custom hardware components 108.

A means for storing different sets of custom hardware components 108 in locations indexed based on an associated plurality of installation projects, in various embodiments, may include one or more of an inventory module 104, a hardware device 102, a backend server 102, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), one or more receptacles, one or more locations in a warehouse or other storage facility, other logic hardware, and/or other executable code stored on a computer readable storage medium. Other embodiments may include similar or equivalent means for storing different sets of custom hardware components 108 in locations indexed based on an associated plurality of installation projects.

Means for performing the other method steps described herein, in various embodiments, may include one or more of an inventory module 104, a hardware device 102, a backend server 102, a network interface, a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), an HDMI or other electronic display dongle, fabrication machinery, robotic equipment, an assembly line, a stamp, a printer, an etching machine, one or more custom hardware components 108, installation equipment/machinery, a hardware appliance or other hardware device, other logic hardware, and/or other executable code stored on a computer readable storage medium. Other embodiments may include similar or equivalent means for performing one or more of the method steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
manufacturing a plurality of custom hardware components for a plurality of installation projects;
serializing the custom hardware components; and
associating the serialized custom hardware components with the plurality of installation projects.

2. The method of claim 1, further comprising completing the plurality of installation projects using the plurality of custom hardware components.

3. The method of claim 2, wherein the plurality of custom hardware components are manufactured, serialized, and associated with the plurality of installation projects in a first year and the plurality of installation projects are completed in a subsequent year.

4. The method of claim 1, further comprising beginning work on the plurality of installation projects in a serialized order of the serialized custom hardware components.

5. The method of claim 1, further comprising storing different sets of the plurality of custom hardware components in locations indexed based on the associated plurality of installation projects.

6. The method of claim 1, wherein at least a predefined minimum number of the plurality of custom hardware components are associated with each of the plurality of installation projects.

7. The method of claim 6, wherein an additional number of subsequently manufactured hardware components are later associated with one or more of the plurality of installation projects.

8. The method of claim 6, wherein the predefined minimum number is selected based on a number of custom hardware components estimated to be used for a smallest project of the plurality of installation projects.

9. The method of claim 1, wherein the plurality of custom hardware components comprise one or more of a photovoltaic panel, a component of a photovoltaic panel, a photovoltaic mounting baseplate, a photovoltaic mounting tile hook, a photovoltaic mounting carriage bolt, a photovoltaic mounting flashing, a photovoltaic mounting L-foot, a photovoltaic racking component, a photovoltaic rail component, a photovoltaic mounting clamp, a photovoltaic inverter, and a photovoltaic support structure.

10. An apparatus comprising:
means for manufacturing a plurality of custom hardware components for a plurality of installation projects;
means for serializing the custom hardware components; and
means for associating the serialized custom hardware components with the plurality of installation projects.

11. The apparatus of claim 10, further comprising means for completing the plurality of installation projects using the plurality of custom hardware components.

12. The apparatus of claim 10, further comprising means for beginning work on the plurality of installation projects in a serialized order of the serialized custom hardware components.

13. The apparatus of claim 10, further comprising means for storing different sets of the plurality of custom hardware components in locations indexed based on the associated plurality of installation projects.

14. The apparatus of claim 10, wherein the plurality of custom hardware components comprise one or more of a photovoltaic panel, a component of a photovoltaic panel, a photovoltaic mounting baseplate, a photovoltaic mounting tile hook, a photovoltaic mounting carriage bolt, a photovoltaic mounting flashing, a photovoltaic mounting L-foot, a photovoltaic racking component, a photovoltaic rail component, a photovoltaic mounting clamp, a photovoltaic inverter, and a photovoltaic support structure.

15. A system comprising:
a plurality of custom manufactured photovoltaic hardware components for a plurality of photovoltaic installation projects;
serialized identifiers disposed on each of the plurality of custom manufactured photovoltaic hardware components, the serialized identifiers indicating at least a date of manufacture; and
a plurality of receptacles physically associating the custom manufactured photovoltaic hardware components with different projects of the plurality of photovoltaic installation projects.

16. The system of claim 15, wherein the plurality of receptacles store different sets of the plurality of custom manufactured photovoltaic hardware components in locations indexed based on the associated plurality of photovoltaic installation projects.

17. The system of claim 15, wherein at least a predefined minimum number of the plurality of custom manufactured photovoltaic hardware components are associated with each of the plurality of photovoltaic installation projects.

18. The system of claim 17, further comprising an additional number of subsequently custom manufactured photovoltaic hardware components, later serialized and associated with one or more of the same plurality of photovoltaic installation projects.

19. The system of claim 17, wherein the predefined minimum number is selected based on a number of custom manufactured photovoltaic hardware components estimated to be used for a smallest project of the plurality of photovoltaic installation projects.

20. The system of claim 15, wherein the plurality of custom manufactured photovoltaic hardware components comprise one or more of a photovoltaic panel, a component of a photovoltaic panel, a photovoltaic mounting baseplate, a photovoltaic mounting tile hook, a photovoltaic mounting carriage bolt, a photovoltaic mounting flashing, a photovoltaic mounting L-foot, a photovoltaic racking component, a photovoltaic rail component, a photovoltaic mounting clamp, a photovoltaic inverter, and a photovoltaic support structure.
